(19) United States
(12) Patent Application Publication
(10) Pub. No.: US 2011/0040868 A1
(43) Pub. Date: Feb. 17, 2011

(54) SERVER INFORMATION SENDING SYSTEM

(75) Inventor: Ting-Kai CHEN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/611,107

(22) Filed: Nov. 2, 2009

(30) Foreign Application Priority Data
Aug. 12, 2009 (TW) 98127181

(51) Int. Cl. G06F 15/173; G08B 21/00; G09F 9/33

(52) U.S. Cl. 709/224; 340/635; 340/815.45

(57) ABSTRACT

A server information sending system includes a server and an optical receiving device. The server has a microprocessor and a single LED element connected the microprocessor. The microprocessor transmits some server information in series outwardly by the single LED element. Flashes having information transmitted by the single LED element includes a machine-received message for the optical receiving device and a naked-eye-received message for a user.

### RELATED APPLICATIONS

This application claims priority to Taiwan Application Serial Number 98127181, filed Aug. 12, 2009, which is herein incorporated by reference.

### FIELD OF THE INVENTION

This invention relates generally to an information sending system, and more particularly, to a server information sending system.

### BACKGROUND OF THE INVENTION

During the conventional server is subjected to a debugging process, a user monitors current statuses of the server only via a serial port (RS232) interface connecting to a supervisor computer. The server and the supervisor computer must have the serial port (RS232) interface respectively, and multiple wires of the serial port (RS232) interface specification are necessary to connect the server and the supervisor computer, so that the supervisor computer can perform the debugging process or acquire the current statuses in the server.

However, as the computer technology proceeds increasingly, and the serial port (RS232) interface is not designed in many computer equipments. During the debugging process or acquisition of the current statuses in the server, the supervisor computer must be additionally installed with external devices having the serial port (RS232) interface, and multiple wires of the serial port (RS232) interface specification are necessary to connect the server and the supervisor computer, thereby performing the debugging process or acquiring the current statuses in the server. When the server is subjected to a debugging process, it is very inconvenient and time-consuming that the user must connect the server and the supervisor computer via the aforementioned wires. Besides, components and wires required for equipping the serial port (RS232) interface cost a lot.

### SUMMARY OF THE INVENTION

Accordingly, it is an aspect of the present invention to provide a server information sending system, thereby eliminating the serial port interface required for a debugging process, saving time required for connecting the prior server and prior monitoring computer with wires, and saving cost of components and wires required for equipping the serial port interface.

Moreover, it is another aspect of the present invention to provide a server information sending system, thereby reducing the amount of the LED elements required for the server to express system information.

According to an embodiment of the present invention, a server information sending system is disclosed, which includes an optical receiving device and a server. The optical receiving device is adjacent to the server. The server may include a host, a microprocessor and a single LED element. After the microprocessor continuously receives and integrates a plurality of server information of the host, the single LED element transmits flashes having information in series outwardly, and the information includes a machine-received message for an optical receiving device and a naked-eye-received message for a user.

In an embodiment of the present invention, the machine-received message and the naked-eye-received message may generate sequentially.

In an embodiment, the machine-received message includes a combination of light and dark signals of the flashes according to a coding algorithm.

In an embodiment, the naked-eye-received message includes a combination of light and dark signals of the flashes according to a comparison table.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a block diagram of a server information sending system according to an embodiment of the present invention.

FIG. 2 depicts a flowchart of a server information sending system according to an embodiment of the present invention.

### DETAILED DESCRIPTION OF THE PREFERRED EMBODIMENT

Reference will now be made in detail to the present embodiments of the invention, examples of which are illustrated in the accompanying drawings. Wherever possible, the same reference numbers are used in the drawings and the description to refer to the same or like parts.

Herein, a server information sending system is disclosed, which includes a server and an optical receiving device. The server may transmit flashes having a plurality of server information in series outwardly via a single LED element. The information transmitted by the single LED element includes a machine-received message for an optical receiving device that receives and determines the information, and a naked-eye-received message for a user who can see.

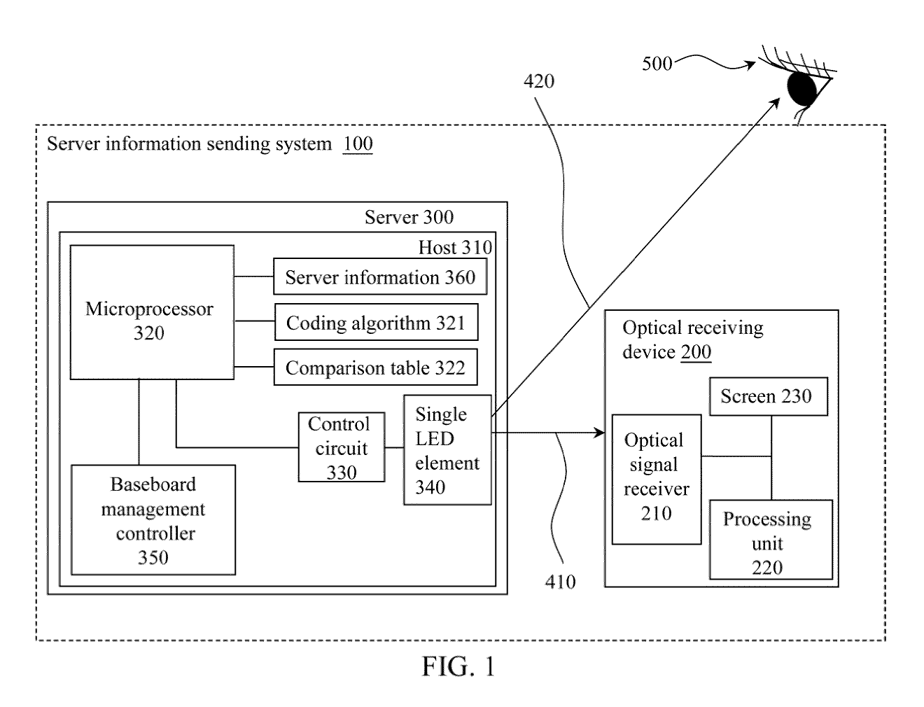

Reference is made to FIG. 1, which depicts a block diagram of a server information sending system according to an embodiment of the present invention. In an embodiment, the server information sending system 100 of the present invention may include a host 310. The host 310 may further include a microprocessor 320, a control circuit 330 and a single LED element 340.

The control circuit 330 and the single LED element 340 are connected electrically, and the microprocessor 320 and the control circuit 330 are connected electrically, too. The single LED element 340 is disposed on the host 310, particularly on a position that can radiate outwardly. For example, the single LED element 340 is disposed on a surface of a housing that exposes the server 310, or it can be seen outside even being disposed in the host 310.

It should be noted that, the single LED element 340 described herein is defined to a LED package structure; however, the single LED element 340 is not limited by only one LED chip die.

In this embodiment of the present invention, the host 310 has the plurality of the server information 360 including at least a system environment information and/or at least a server dealing feedback, for example. The system environment information is some status information that is related to the server 310 and monitored by a user, for example, a system thermal event, a system power status, a system health status, a system event status, a remove event status, a wake on lane status or any combinations thereof.

With respect to changes of system environment information, a baseboard management controller (BMC) 350 informs the host 310 about the server dealing feedback, for example, a reboot feedback, an on-line feedback or any combinations thereof.

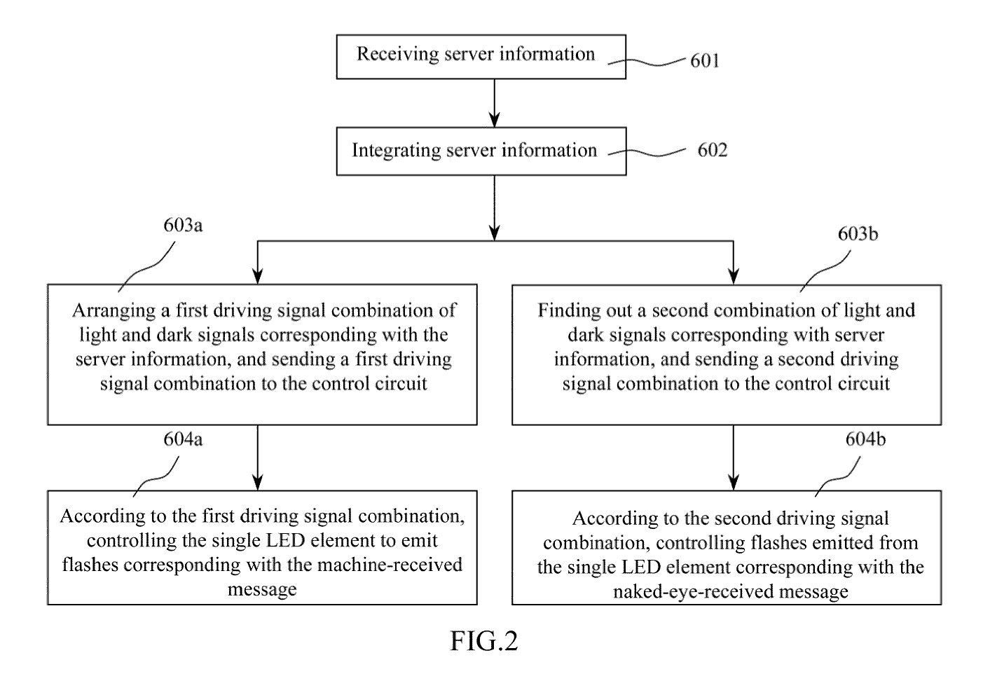

Reference is made to the FIGS. 1 and 2, in which FIG. 2 depicts a flowchart of a server information sending system according to an embodiment of the present invention. In this embodiment, after a user performs a debugging process of the server 300, the microprocessor 320 is performed as follows.

In the step 601, at least a system environment information and/or at least a server dealing feedback are received.

In the step 602, the system environment information and/or the server dealing feedback are integrated.

In the step 603a, a first driving signal combination of light and dark signals is arranged according to a coding algorithm 321 for corresponding with the system environment information and/or the server dealing feedback, so as to prepare and send a first driving signal combination to the control circuit 330 for driving the single LED element 340. Packets may be applied in the coding algorithm 321 according to a packet decoding method. The first driving signal combination of light and dark signals may sequentially include, for example, a START bit, multiple (e.g. 8) data packets and an END bit.

In the step 604a, according to the indication of the first driving signal combination, the control circuit 330 can control the single LED element 340 to emit flashes of the first combination of light and dark signals.

For example, after a system information 360 about “system thermal event: 80° C.” is coded according to the coding algorithm 321, the microprocessor 320 sends the first driving signal combination. According to an indication of the first driving signal combination, the control circuit 330 controls the single LED element 340 to emit flashes of the specific combination of light and dark signals in the desired times per second. Thus, the optical receiving device 200 can receive and decode to the system information 360 about “system thermal event: 80° C.” that the host 310 informs.

In this embodiment, in addition to the machine-received message 410, after the step 601, the microprocessor 320 further provides a naked-eye-received message 420 as follows.

In the step 603b, a second driving signal combination of light and dark signals is found out according to a comparison table 322 for corresponding with the system environment information and/or the server dealing feedback, so as to prepare and send a second driving signal combination to the control circuit 330 for driving the single LED element 340.

In the step 604b, according to the indication of the second driving signal combination, the control circuit 330 can control the single LED element 340 to emit flashes of the second combination of light and dark signals.

For example, after a system information 360 about “system thermal event: 80° C.” is compared according to the comparison table 322 and the second combination of light and dark signals is found out, the microprocessor 320 sends the second driving signal combination. According to an indication of the second driving signal combination, the control circuit 330 controls the single LED element 340 to emit flashes of the specific combination of light and dark signals in a rapid frequency. Meanwhile, the user can see the flashes in once per second and realize that the system information 360 about “system thermal event: 80° C.” that the host 310 informs.

It is worth mentioning that, the user hardly distinguishes too many kinds of the system information 360 or numerical values of specific system environment information via the naked eyes 500, and thus the naked-eye-received message 420 is more rough and primary than the machine-received message 410 while the system information is conversion to the naked-eye-received message 420 and the machine-received message 410. In an example, various colored lights can be applied in the second combination of light and dark signals for prompting the messages.

Besides, the coding algorithm 321 and the comparison table 322 may be pre-designed agreements or be modified depending on actual statuses and demands. One skilled in the art can code the information and decode the coded content according the coding algorithm 321.

Furthermore, the machine-received message 410 and the naked-eye-received message 420 can be sent in series outwardly. For example, the naked-eye-received message 420 is sent firstly, the machine-received message 410 is sent later, and vice versa. Alternatively, the machine-received message 410 can be intervened between light and dark signals of the second combination of the naked-eye-received message 420.

The optical receiving device 200 adjacent to the server 300 may include an optical signal receiver 210 and a processing unit 220. The optical receiving device 200 may be a portable electrical device with the optical signal receiver 210. The portable electrical device may be one of a notebook computer, a mobile phone or a personal digital assistance (PDA), for example. The optical signal receiver 210 is disposed on the optical receiving device 200, particularly on the position capable of receiving the machine-received message 410. The processing unit 220 is connected electrically to the optical signal receiver 210 for reading the coding algorithm 321 in the optical receiving device 200, in which the coding algorithm 321 is the same as above mentioned. The optical receiving device 200 may further include a screen 230.

When the optical signal receiver 210 of the optical receiving device 200 receives the machine-received message 410, the processing unit 220 of the optical receiving device 200 can convert the machine-received message 410 to the original system information 360, and provide an external report shown on the screen 230.

Therefore, during the debugging process is performed in the server 300, a portable electrical device can detect and receive the flashes having information that is sent from the single LED element 340 of the server 300, resulting that the user can readily understand the system information 360 of the server 300 during the debugging process, instead of preparation of components and wires required for bridging the serial port interface. In addition, whether the user uses the portable electrical device or not, the user can observe the flashes of the naked-eye-received message and understand a primary system information 360 by eyes 500.

It should be supplemented that, a single LED element emphasized herein is employed to transmit the server information in such manner, rather than limiting to the whole server that has only one LED element.

As is understood by a person skilled in the art, the foregoing embodiments of the present invention are illustrated of the present invention rather than limiting of the present invention. It is intended to cover various modifications and similar arrangements included within the spirit and scope of the appended claims. Therefore, the scope of which should be accorded to the broadest interpretation so as to encompass all such modifications and similar structure.

What is claimed is:

1. A server device, comprising:
a host;
a single light emitting diode (LED) element disposed on the host, wherein the single LED element radiates outwardly from the host; and
a microprocessor connecting the single LED element,
wherein after the microprocessor continuously receives a plurality of server information of the host, the single LED element transmits flashes having information in series outwardly, and the information includes a machine-received message for an optical receiving device and a naked-eye-received message for a user.

2. The server device according to claim 1, wherein the machine-received message includes a combination of light and dark signals of the flashes according to a coding algorithm.

3. The server device according to claim 1, wherein the naked-eye-received message includes a combination of light and dark signals of the flashes according to a comparison table.

4. The server device according to claim 1, wherein the machine-received message and the naked-eye-received message are generate sequentially.

5. The server device according to claim 1, wherein each of the server information includes a system environment information and a server dealing feedback.

6. The server device according to claim 5, wherein the system environment information is a system thermal event, a system power status, a system health status, a system event status, a remove event status, a wake on lane status or any combinations thereof.

7. The server device according to claim 5, wherein the server dealing feedback is a reboot feedback, an on-line feedback or any combinations thereof.

8. A server information sending device, comprising:
a server, comprising:
a microprocessor, wherein after the microprocessor receives and integrates a plurality of server information of the server device, (1) a first driving signal combination is obtained according to a coding algorithm, or (2) a second driving signal combination is obtained according to a comparison table; and
a single LED element disposed on the microprocessor, wherein the single LED element outwardly transmits (1) flashes having a machine-received message that is conversed from the server information according to a coding algorithm, or (2) flashes having a naked-eye-received message that is compared and determined from the server information according to a comparison table; and
a portable electrical device adjacent to the server, comprising:
an optical receiving unit for receiving the flashes having the machine-received message; and
a processing unit connecting to the optical receiving unit for converting the machine-received message back to the server information according the coding algorithm.

9. The server information sending device according to claim 8, wherein the machine-received message includes a combination of light and dark signals of the flashes.

10. The server information sending device according to claim 8, wherein the naked-eye-received message includes a combination of light and dark signals of the flashes.
